(19) United States
(12) Patent Application Publication
(10) Pub. No.: US 2025/0065608 A1
(43) Pub. Date: Feb. 27, 2025

(54) Decorative Member, Laminate for Decorative Member, and Method for Manufacturing Decorative Member

(71) Applicant: Yamaha Fine Technologies Co., Ltd., Hamamatsu-shi (JP)

(72) Inventors: Masahiro HIRATO, Hamamatsu-shi (JP); Shuto Suzuki, Hamamatsu-shi (JP); Hikaru Ubukata, Hamamatsu-shi (JP); Yoshihito Yamamoto, Iwata-shi (JP)

(21) Appl. No.: 18/791,724

(22) Filed: Aug. 1, 2024

(30) Foreign Application Priority Data
Aug. 24, 2023 (JP) 2023-136411

(51) Int. Cl. B32B 21/08; B29C 45/14; B29C 65/00; B29K 711/14; B29L 31/30; B32B 3/26; B32B 3/30; B32B 21/14

(52) U.S. Cl. CPC B32B 21/08; B29C 45/14336; B29C 45/14344; B29C 66/45; B29C 66/7487; B32B 3/266; B32B 3/30; B32B 21/14; B29K 2711/14; B29L 2031/3041; B32B 2250/03; B32B 2250/40; B32B 2260/026; B32B 2260/046; B32B 2307/7375; B32B 2307/7376; B32B 2451/00; B32B 2605/003

(57) ABSTRACT

A decorative member includes a board, a resin film, and a resin layer. The board includes a cut-out pattern portion, a first surface, and a second surface. The resin film is disposed on the first surface of the board. The resin layer is disposed on the second surface of the board. The cut-out pattern portion includes a through-hole which penetrates the board in a thickness direction thereof.

### BACKGROUND

The present disclosure relates to a decorative member, a laminate for a decorative member, and a method for manufacturing a decorative member.

A decorative member that leverages woodgrain as a design element is used as an interior member or the like of an automobile (see Patent Document 1).

Patent Document 1: German Utility Model No. 202021101625

Patent Document 1 discloses a molded product for a vehicle interior, the molded product including a decorative layer constituted by a board having an opening. Patent Document 1 discloses a configuration including: a barrier layer being laminated on a back face of the decorative layer and penetrating into the opening; and a carrier disposed on the back face side of the decorative layer to be isolated from the decorative layer by the barrier layer. The molded product disclosed in Patent Document 1 is formed by an injection molding process in which, in the state where the barrier layer is laminated on the back face of the decorative layer, the decorative layer is disposed in a cavity of a mold, and a carrier material is introduced from a back face side of the barrier layer.

In the decorative member used in the interior member or the like for a vehicle, providing the decorative layer with a cut-out pattern such as a cut-out letter, a cut-out illustration, and/or the like can also be considered. However, in the configuration disclosed in Patent Document 1, in a case in which the cut-out pattern has a through-hole which penetrates the decorative layer, it may be difficult to form an inner peripheral portion of the through-hole into a desired shape.

### SUMMARY

The present disclosure was made in view of the foregoing circumstances, and an object of the present disclosure is to provide a decorative member that enables easily obtaining a desired cut-out pattern.

(1) A decorative member according to one aspect of the present disclosure includes: a board having a cut-out pattern portion; a resin film disposed on a first surface of the board; and a resin layer disposed on a second surface of the board, wherein the cut-out pattern portion has a through-hole which penetrates the board in a thickness direction.
(2) In the above (1), it is preferable that the through-hole is filled with the resin layer, and that the resin film and the resin layer are adhered to each other at an end on the first surface side in the through-hole.
(3) In the above (1) or (2), a minimum width of the through-hole is preferably 0.2 mm or more and 0.4 mm or less.
(4) In any one of the above (1) to (3), the cut-out pattern portion preferably has a separated piece which is disposed in the through-hole to be apart from an inner periphery of the through-hole.
(5) In the above (4), a surface area of the separated piece is preferably 0.03 mm² or more.
(6) In any one of the above (1) to (5), an average thickness of the board is preferably 0.1 mm or more and 0.5 mm or less.
(7) In any one of the above (1) to (6), the decorative member preferably further includes a decorative resin which impregnates the first surface of the board, wherein the resin film and the decorative resin are adhered to each other.
(8) A laminate for a decorative member according to another aspect of the present disclosure includes: a board having a cut-out pattern portion; and a resin film adhered to a first surface of the board, wherein the cut-out pattern portion has a through-hole which penetrates the board in a thickness direction.
(9) A method for manufacturing a decorative member according to still another aspect of the present disclosure includes: adhering a resin film to a first surface of a board having a cut-out pattern portion; disposing, in a cavity of a mold, the board having the resin film adhered thereto; and supplying an injection resin to a second surface of the board disposed in the cavity, wherein the cut-out pattern portion has a through-hole which penetrates the board in a thickness direction.

It is to be noted that the expression “the resin film and the resin layer are adhered to each other at an end on the first surface side in the through-hole,” as referred to herein, encompasses a configuration in which the resin film and the resin layer are adhered to each other on an extended plane of the first surface, and a configuration in which the resin film and the resin layer are adhered to each other in a state where the resin film slightly enters the second surface side beyond the extended plane. The “surface area of the separated piece” means an area on the first surface of the separated piece. The “average thickness” means an average value of thicknesses at 10 arbitrary points.

Since the decorative member according to the one aspect of the present disclosure includes the resin film disposed on the first surface of the board, the inner peripheral portion of the through-hole can be supported by the resin film. Thus, in the decorative member, in the state where the board is supported by the resin film to have a desired shape, the resin layer can be easily disposed on the second surface of the board. Accordingly, the decorative member enables easily obtaining a desired cut-out pattern.

### BRIEF DESCRIPTION OF THE DRAWINGS

FIG. 1 is a schematic plan view illustrating a decorative member;

FIG. 2 is a II-II line cross-sectional view of the decorative member in FIG. 1;

FIG. 3 is a schematic perspective view of a board in the decorative member in FIG. 1;

FIG. 4 is a schematic partial enlarged cross-sectional view illustrating a modified example of the decorative member in FIG. 1;

FIG. 5 is a flowchart illustrating a method for manufacturing a decorative member;

FIG. 6 is a schematic cross-sectional view illustrating a state where a resin film is adhered to a board in the manufacturing method in FIG. 5;

FIG. 7 is a schematic perspective view illustrating the state where the resin film is adhered to the board;

FIG. 8 is a schematic cross-sectional view illustrating a state where a laminate of the board and the resin film is disposed in a cavity of a mold in the manufacturing method in FIG. 5; and

FIG. 9 is a schematic cross-sectional view illustrating a light-emitting module including the decorative member in FIG. 1.

### DETAILED DESCRIPTION

Hereinafter, embodiments of the present disclosure will be described in detail with reference to the drawings as appropriate. It is to be noted that with regard to numerical values disclosed herein, it is possible to adopt only one of the upper limit value and the lower limit value disclosed, or to arbitrarily combine an upper limit value with a lower limit value. Herein, an entire range of numerical values that can be combined shall be disclosed as a suitable range. Furthermore, each drawing is merely a schematic illustration and may not necessarily correspond to an actual dimension, proportion, and/or the like. In the present disclosure, the terms “first” and “second” are used to distinguish components denoted by these terms and do not limit the number, the order, priorities, or the like.

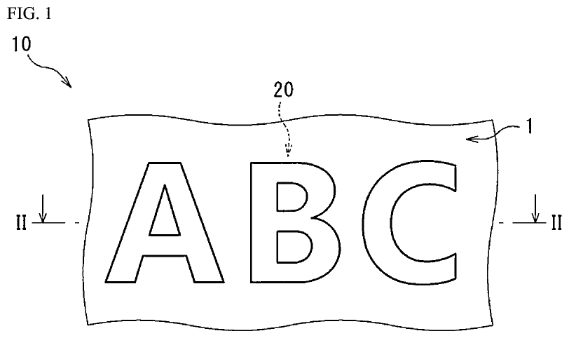

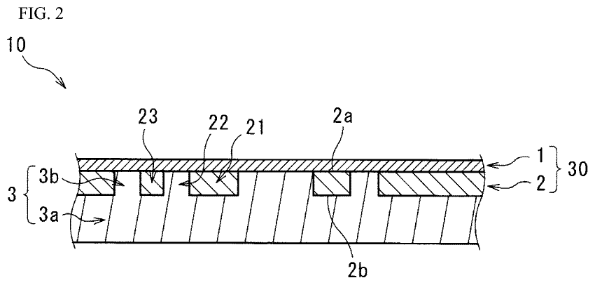

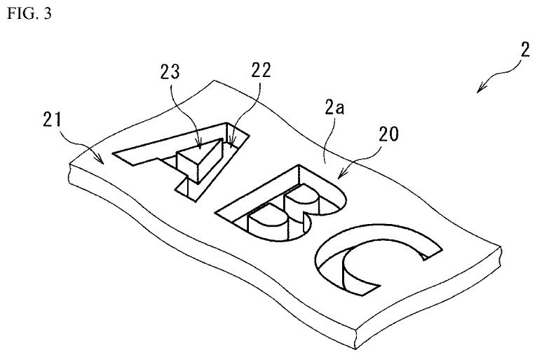

A decorative member 10 illustrated in FIGS. 1 and 2 includes: a board 2 having a cut-out pattern portion 20 (see FIG. 3); a resin film 1 disposed on a first surface 2a of the board 2; and a resin layer 3 disposed on a second surface 2b of the board 2. The first surface 2a and the second surface 2b are positioned opposite to each other in a thickness direction of the board 2. The cut-out pattern portion 20 has a through-hole 22 which penetrates the board 2 in the thickness direction.

Furthermore, the cut-out pattern portion 20 has a separated piece 23 which is disposed in the through-hole 22 to be apart from an inner periphery of the through-hole 22. In other words, in the board 2, a board main body 21 and the separated piece 23 separately exist with a space therebetween, the space being formed by the through-hole 22. In the board 2, the through-hole 22 and the separated piece 23 are not particularly limited in number. The board 2 may have a through-hole 22 without the separated piece 23 disposed therein.

In the decorative member 10, the resin film 1, the board 2, and the resin layer 3 are directly laminated in this order from a viewer side. The decorative member 10 can be used in, for example, interior panels (a door trim, a decorative cover for a center console, a decorative cover for a dashboard, etc.) of an automobile and/or the like. The decorative member 10 may also serve as: a warning display regarding seat belt(s), door lock(s), etc.; a display device for an air conditioner, audio equipment, etc.; and/or the like.

Since the decorative member 10 includes the resin film 1 disposed on the first surface 2a of the board 2, the inner peripheral portion of the through-hole 22 can be supported by the resin film 1. Thus, in the decorative member 10, in the state where the board 2 is supported by the resin film 1 to have a desired shape, the resin layer 3 can be easily disposed on the second surface 2b of the board 2. Accordingly, the decorative member 10 enables easily obtaining a desired cut-out pattern.

Furthermore, since the decorative member 10 includes the resin film 1 disposed on the first surface 2a of the board 2, the separated piece 23 can be supported by the resin film 1. Thus, in the decorative member 10, in the state where the separated piece 23 is supported by the resin film 1, the resin layer 3 can be easily disposed on the second surface 2b of the board 2. In other words, in the decorative member 10, in a state where the board main body 21 and the separated piece 23 are positioned on the resin film 1, preferably in a state where the board main body 21 and the separated piece 23 are adhered to the resin film 1, the resin layer 3 can be easily disposed on the second surface 2b of the board 2. Accordingly, the decorative member 10 enables a desired cut-out pattern to be obtained more easily.

The resin film 1 may constitute a top layer (a layer exposed on the viewer side) of the decorative member 10. The resin film 1 has an adhesive face that faces the first surface 2a of the board 2. The board main body 21 and the separated piece 23 are fixed to the adhesive face.

As described above, when the decorative member 10 includes the resin film 1, the board main body 21 and the separated piece 23 can be easily positioned. Furthermore, when the decorative member 10 includes the resin film 1, uniformity of a thickness of such a resin layer disposed on the viewer side with respect to the board 2 can be easily achieved, and manufacturing efficiency can be easily increased. In other words, if a coating layer is provided instead of the resin film 1, positioning of the board 2 is difficult, and also, coating unevenness is likely to occur, leading to an uneven thickness. Furthermore, waste of a solvent and the like is generated in the coating process, whereby the environmental load is increased. In contrast, according to the decorative member 10, a precisely processed resin layer can be easily formed, while suppressing the environmental load.

The resin film 1 has flexibility. The resin film 1 may be transparent. A principal component of the resin film 1 is exemplified by: vinyl resins such as polyvinyl chlorides and polyvinyl acetates; thermoplastic resins such as acrylic resins, polyolefins, polystyrenes, acrylonitrile-butadiene-styrene copolymers (ABS resins), polyesters, polycarbonates, cellulose resins, polyamides, thermoplastic polyurethanes, and fluorine resins; and thermosetting resins such as epoxy resins and thermosetting polyurethanes. It is to be noted that the “principal component” as referred to herein means a component having the highest content, and means, for example, a component having a content of 50% by mass or more.

A thickness of the resin film 1 is not particularly limited, and in light of ease of expressing a texture of the board 2, is preferably small. In light of appropriately supporting the board 2, the lower limit of an average thickness of the resin film 1 is preferably 10 μm and more preferably 30 μm. On the other hand, in light of enabling sufficiently expressing the texture of the board 2, the upper limit of the average thickness of the resin film 1 is preferably 150 μm, more preferably 100 μm, and still more preferably 80 μm. Furthermore, in light of recreating a texture like mirror coating, the thickness of the resin film 1 is preferably large. In this case, the lower limit of the average thickness of the resin film 1 is preferably 500 μm and more preferably 1,000 μm.

The resin film 1 may have an adhesive layer as a surface layer on the side on which the resin film 1 is adhered to the board 2. Furthermore, within a range in which the effects of the present disclosure can be exhibited, the resin film 1 may contain other optional component(s). Moreover, in light of obtaining a desired decorative effect and the like, the decorative member 10 may include a coating layer laminated on the resin film 1. Even in the case of including the coating layer laminated on the resin film 1, the decorative member 10 easily enables reducing the environmental load and the like as compared with conventional decorative members.

The board 2 is configured to enable expressing a cut-out pattern such as a letter, a figure, etc. by using the board main body 21, the through-hole 22, and the separated piece 23; the board main body 21 and the separated piece 23 define outlines of the cut-out pattern. As illustrated in FIG. 3, the board 2 has, for example, a plurality of through-holes 22 (of the plurality of through-holes 22, there may exist a through-hole 22 without the separated piece 23 disposed therein), and one cut-out pattern portion 20 consists of a design expressed by: the through-holes 22; and the board main body 21 and the separated piece 23 which are disposed inside and outside of the through-holes 22.

In the case in which the through-hole 22 without the separated piece 23 disposed therein exists in the board 2, the lower limit of a minimum width of the through-hole 22 is, in light of enabling a viewer to easily recognize the cut-out pattern, preferably 0.2 mm and more preferably 0.25 mm. On the other hand, the upper limit of the minimum width of the through-hole 22 may be, for example, 0.4 mm or may be 0.35 mm.

In light of enabling a viewer to easily recognize the cut-out pattern, the lower limit of a surface area of the separated piece 23 may be 0.03 mm² or may be 0.06 mm².

The through-hole 22 is preferably formed such that a central axis thereof extends in the thickness direction of the board 2. The through-hole 22 may be formed in a tapered shape. For example, the through-hole 22 may be provided so as to have a diameter expanding from the first surface 2a toward the second surface 2b of the board 2. Such a configuration facilitates increasing a viewing angle of the cut-out pattern portion 20, while inhibiting an inner peripheral face of the through-hole 22 from being visible to a viewer.

In light of processability and inhibiting a decrease in visibility of woodgrain, the lower limit of an average thickness of the board 2 is preferably 0.1 mm and more preferably 0.2 mm. On the other hand, in light of easily and surely filling the through-hole 22 with the resin layer 3 and the like, the upper limit of the average thickness may be 0.5 mm or may be 0.4 mm.

The board 2 may be a laminate of a plurality of veneers but preferably consists of a single veneer. As a material of the board 2, for example, a rotary veneer obtained by cutting a log circumferentially so as to peel the log, a sawn veneer obtained by cutting raw timber with a saw, a sliced veneer obtained by slicing raw timber with a sharp cutter, or the like may be used. It is possible to make a rotary veneer with a width greater than the thickness of the raw timber, and thus, large rotary veneers can be obtained at relatively low cost. Accordingly, using a rotary veneer as the board 2 enables relatively easy and affordable enlargement of the decorative member 10. In addition, by using a rotary veneer as the board 2, it is possible to inhibit deformation of the decorative member 10 resulting from a change in humidity or a change over time. In a case in which a rotary veneer is used as the board 2, the decorative member 10 has an appearance similar to that of a cross-grain board from natural wood and has relatively stable quality.

A type of wood for the board 2 is not particularly limited and may be selected such that a desired design can be obtained, and examples thereof include walnut, maple, and ash. As illustrated in FIG. 2, the resin film 1 is directly laminated on the first surface 2a of the board 2. Due to such a configuration, the board main body 21 and the separated piece 23 are directly fixed to the resin film 1 on the first surface 2a.

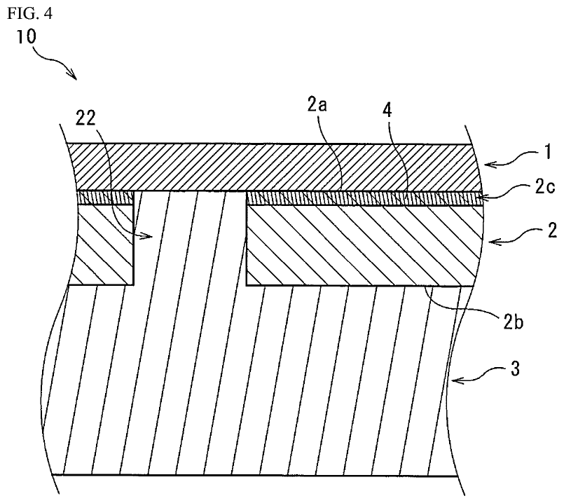

As illustrated in FIG. 4, a decorative resin 4 may impregnate the first surface 2a of the board 2. That is to say, the board 2 may have, as a surface layer on the first surface 2a side, a resin impregnation portion 2c impregnated with the decorative resin 4. According to this configuration, the resin film 1 is disposed so as to be in contact with the resin impregnation portion 2c.

The resin of the resin film 1 and a resin of the resin impregnation portion 2c are preferably adhered to each other, and it is more preferable that these resins are chemically bonded to each other. That is to say, the decorative member 10 includes the decorative resin 4 which impregnates the first surface 2a of the board 2, wherein the resin film 1 and the decorative resin 4 are preferably adhered to each other, and more preferably, the resin contained in the resin film 1 is chemically bonded to the decorative resin 4. Such a configuration enables the board main body 21 and the separated piece 23 to be easily and surely fixed to the resin film 1 on the first surface 2a.

A principal component of the decorative resin 4 may be selected in accordance with the intended use, and selection in light of adhesiveness to the resin contained in the resin film 1 is also preferable. Examples of the principal component of the decorative resin 4 include: vinyl resins such as polyvinyl chlorides and polyvinyl acetates; thermoplastic resins such as acrylic resins, polyolefins, polystyrenes, ABS resins, polyesters, polycarbonates, cellulose resins, polyamides, thermoplastic polyurethanes, and fluorine resins; and thermosetting resins such as epoxy resins and thermosetting polyurethanes. The principal component of the decorative resin 4 may be the same as or different from the resin contained in the resin film 1. When the principal component of the decorative resin 4 is the same as the resin contained in the resin film 1, the adhesiveness between the resin film 1 and the board 2 can be easily improved. On the other hand, when the principal component of the decorative resin 4 is different from the resin contained in the resin film 1, a decorative effect based on the decorative resin 4 can be easily enhanced.

For example, the resin layer 3 is formed in such a manner that an injection resin supplied to the second surface 2b of the board 2 is cured. In this case, the resin layer 3 is configured as an injection resin layer. The resin layer 3 is laminated on the second surface 2b of the board 2 and fills the through-hole 22. Furthermore, in the case in which the separated piece 23 is disposed in the through-hole 22, the resin layer 3 fills a gap between the inner periphery of the through-hole 22 and the separated piece 23. That is to say, as illustrated in FIG. 2, the resin layer 3 has: a first part 3a laminated on the second surface 2b (and an extended plane of the second surface 2b) of the board 2; and a second part 3b filling the through-hole 22. The first part 3a and the second part 3b are integrally formed of the same injection resin. The first part 3a is directly adhered to the second surface 2b of the board 2. On a tip opposite to the first part 3a, the second part 3b is directly adhered to the resin film 1. It is to be noted that a procedure for forming the resin layer 3 is not particularly limited. For example, the resin layer 3 may also be formed by curing a resin applied to the second surface 2b of the board 2.

In the decorative member 10, the resin film 1 and the resin layer 3 are preferably adhered to each other at an end on the first surface 2a side in the through-hole 22. In this case, the resin film 1 and the resin layer 3 may be adhered to each other on an extended plane of the first surface 2a. In the decorative member 10, warpage of the resin film 1 can be easily inhibited in the through-hole 22, and thus, the resin film 1 and the resin layer 3 can be easily adhered to each other on the extended plane of the first surface 2a. Furthermore, it is also preferable that the resin of the resin film 1 is chemically bonded to a resin of the resin layer 3. When such a configuration is employed, the decorative member 10 enables increasing the manufacturing efficiency, while fixing the inner peripheral portion of the through-hole 22 and the separated piece 23 in desired positions.

Examples of the injection resin include thermoplastic resins such as acrylic resins, polycarbonates, ABS resins, acrylonitrile-ethylene-propylene-diene-styrene copolymers (AES resins), acrylonitrile-styrene-acrylate copolymers (ASA resins), and acrylonitrile-styrene copolymers (AS resins).

In light of satisfying a necessary strength and the like, the lower limit of an average thickness of the resin layer 3 (average thickness of the first part 3a) may be 1.0 mm or may be 1.5 mm. On the other hand, in light of promoting a thickness reduction of the decorative member 10 and the like, the upper limit of the average thickness may be 6.0 mm or may be 5.0 mm.

As described above, the decorative member 10 includes: the board 2 having the cut-out pattern portion 20; and the resin film 1 adhered to the first surface 2a of the board. A laminate 30 for a decorative member (see FIG. 2), in which the board 2 and the resin film 1 are laminated, is an aspect of the present disclosure. That is to say, the laminate 30 for a decorative member includes: the board 2 having the cut-out pattern portion 20; and the resin film 1 adhered to the first surface 2a of the board 2. The cut-out pattern portion 20 has the through-hole 22 which penetrates the board 2 in the thickness direction. Furthermore, the cut-out pattern portion 20 has a separated piece 23 which is disposed in the through-hole 22 to be apart from the inner periphery of the through-hole 22.

Since the laminate 30 for a decorative member includes the resin film 1 adhered to the first surface 2a of the board 2, the inner peripheral portion of the through-hole 22 and the separated piece 23 can be supported by the resin film 1. Accordingly, the laminate 30 for a decorative member enables easily obtaining a desired cut-out pattern.

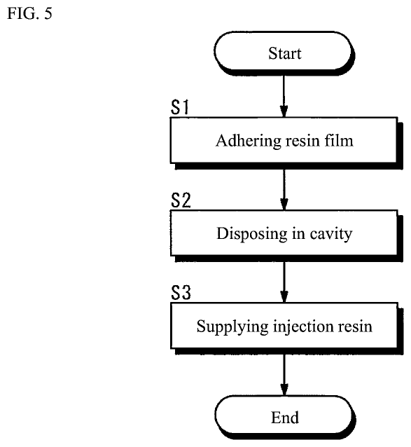

An example of a method for manufacturing the decorative member (hereinafter, may be simply referred to as “the manufacturing method”) is described with reference to FIG. 5. In the manufacturing method, a resin film is adhered to a first surface of a board having a cut-out pattern portion (S1), the board having the resin film adhered thereto is disposed in a cavity of a mold (S2), and an injection resin is supplied to a second surface of the board disposed in the cavity (S3). In the manufacturing method, the cut-out pattern portion has a through-hole which penetrates the board in a thickness direction. Furthermore, in the manufacturing method, the cut-out pattern portion has a separated piece which is disposed in the through-hole to be apart from an inner periphery of the through-hole.

In the manufacturing method, the laminate of the resin film and the board is disposed in the cavity of the mold in the state where the board is adhered to the resin film; therefore, a misalignment of the board with respect to the resin film is less likely to occur at the time of supplying and curing the injection resin. Thus, according to the manufacturing method, a desired cut-out pattern can be easily formed.

Hereinafter, each step of the manufacturing method is described taking, as an example, the case of manufacturing the decorative member 10 in FIGS. 1 and 2. It is to be noted that in the following description, specific configurations of the resin film 1, the board 2, and the resin layer 3 may be similar to those of the decorative member 10 in FIGS. 1 and 2.

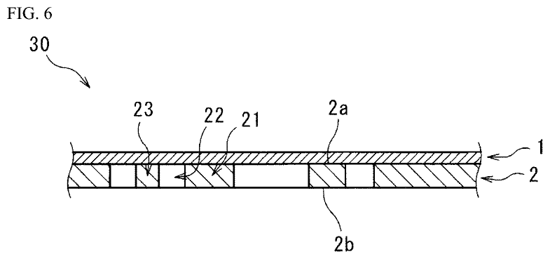

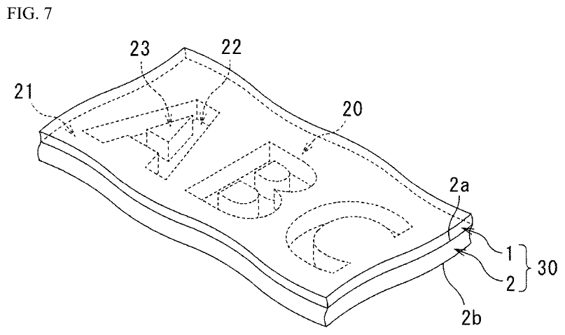

In S1 (hereinafter, may be referred to as “adhering step S1”), as illustrated in FIGS. 6 and 7, the board main body 21 and the separated piece 23 are fixed to the surface of the resin film 1. In the adhering step S1, to obtain a desired cut-out pattern, after the board main body 21 and the separated piece 23 are aligned with respect to the resin film 1, the board main body 21 and the separated piece 23 are adhered to the resin film 1.

In the adhering step S1, for example, the resin film 1 and the board 2 may be adhered to each other by hot-pressing the resin film 1 to the first surface 2a of the board 2, or an adhesive layer may be formed as a surface layer of the resin film 1 on the side to be adhered to the board 2, allowing the adhesive layer to adhere between the resin film 1 and the board 2. Furthermore, in the adhering step S1, the first surface 2a of the board 2 may be impregnated with the decorative resin to adhere the resin contained in the resin film 1 and the decorative resin to each other. In this case, it is preferable that the resin contained in the resin film 1 is chemically bonded to the decorative resin. It is to be noted that at the time of adhering the board 2 to the resin film 1, the second surface 2b of the board 2 may be supported by another member.

The laminate of the resin film 1 and the board 2 formed in the adhering step S1 is configured as the above-described laminate 30 for a decorative member.

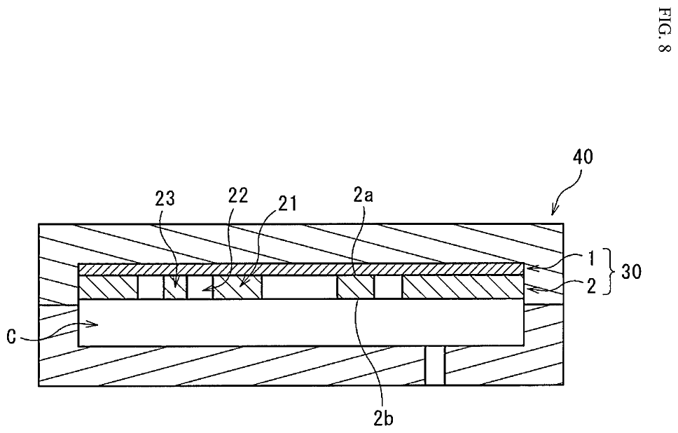

S2 (hereinafter, may be referred to as “disposing step S2”), as illustrated in FIG. 8, the laminate 30 for a decorative member is disposed in a cavity C of a mold 40. In the disposing step S2, the laminate 30 for a decorative member is disposed in the cavity C such that the surface of the resin film 1 is in contact with an inner face of the mold 40. In the disposing step S2, the laminate 30 for a decorative member is preferably disposed in the cavity C such that an entirety of the surface of the resin film 1 is supported by the inner face of the mold 40.

In the manufacturing method, since the board 2 is adhered to the resin film 1 by the adhering step S1, a misalignment of the separated piece 23 with respect to the resin film 1 can be inhibited in the disposing step S2. Thus, by positioning the resin film 1 in the cavity C, positioning of the separated piece 23 in the cavity C can be concurrently achieved.

In S3 (hereinafter, may be referred to as “supplying step S3”), in the state where the laminate 30 for a decorative member is disposed in the cavity C, the injection resin is supplied to the second surface 2b of the board 2. Thus, the injection resin is laminated on the second surface 2b of the board 2 and fills the through-hole 22. Furthermore, in the case in which the separated piece 23 is disposed in the through-hole 22, the injection resin fills the gap between the inner periphery of the through-hole 22 and the separated piece 23.

In the supplying step S3, after supplying the injection resin, the injection resin is cured to form the resin layer 3 on the second surface 2b of the board 2. As a result, the decorative member 10 in FIGS. 1 and 2 is obtained.

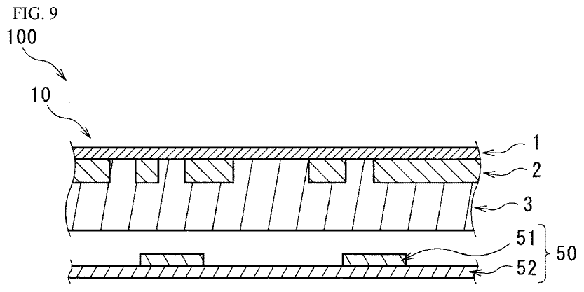

A light-emitting module 100 in FIG. 9 includes: the decorative member 10; and a light-emitting portion 50 disposed on a back face side of the resin layer 3 in the decorative member 10. The light-emitting portion 50 has: one or a plurality of light sources 51; and a support 52 for supporting the one or the plurality of light sources 51. The light source(s) 51 is/are not particularly limited and can be exemplified by an LED, a fluorescent lamp, and the like. In the configuration with the plurality of light sources 51, the light-emitting portion 50 may be configured to enable partly turning on and off these light sources 51.

Since the light-emitting module 100 includes the light-emitting portion 50 on a back face side of the decorative member 10, the visibility of the cut-out pattern formed in the board 2 can be improved.

The above-described embodiments do not limit the configuration of the present invention. Therefore, in the above-described embodiments, components of each part of the above-described embodiments can be omitted, replaced, or added based on the description in the present specification and general technical knowledge, and such omission, replacement, or addition should be construed as falling within the scope of the present invention.

In the decorative member, the resin film, the board, and the resin layer are directly laminated in this order, whereby a desired cut-out pattern portion can be formed to have a simple structure. However, the present disclosure does not exclude a configuration with another layer provided between the resin film and the board, or a configuration with another layer provided between the board and the resin layer. That is to say, the decorative member may also adopt a configuration in which the resin film is indirectly disposed over the first surface of the board, or a configuration in which the resin layer is indirectly disposed over the second surface of the board.

In the decorative member, the resin film is disposed on the first surface of the board, whereby the resin film and the resin layer can be easily adhered to each other at the end on the first surface side in the through-hole. However, in the through-hole, the resin film and the resin layer may be adhered to each other at a part other than the end on the first surface side. Furthermore, the decorative member may also have a configuration in which the through-hole is filled with a component aside from the injection resin.

In the above-described embodiments, the configuration in which the cut-out pattern portion has the separated piece which is disposed in the through-hole to be apart from the inner periphery of the through-hole has been described. However, the decorative member may also adopt a configuration without the separated piece. In the decorative member, for example, in a configuration in which an edge protruding into the through-hole is formed on the inner periphery of the through-hole, the edge can be supported by the resin film to have a desired shape. As a result, the decorative member enables easily obtaining a desired cut-out pattern.

In the laminate for a decorative member, a layer other than the resin layer may be laminated on the second surface of the board.

The decorative member is not required to be used as a member constituting the aforementioned light-emitting module. Furthermore, the configuration of the light-emitting portion in the light-emitting module is not limited to the configuration of the above-described embodiment. Moreover, the light-emitting module may include, for example, another layer such as a masking layer or the like for partly blocking light emitted from the light-emitting portion, and may include another member such as a touch sensor or the like for controlling the emission or non-emission of the light-emitting portion.

What is claimed is:

1. A decorative member comprising:
a board comprising a cut-out pattern portion, a first surface, and a second surface;
a resin film disposed on the first surface of the board; and
a resin layer disposed on the second surface of the board,
wherein the cut-out pattern portion comprises a through-hole which penetrates the board in a thickness direction thereof.

2. The decorative member according to claim 1, wherein
the through-hole is filled with the resin layer, and
the resin film and the resin layer are adhered to each other at an end on the first surface in the through-hole.

3. The decorative member according to claim 1, wherein a minimum width of the through-hole is between 0.2 mm and 0.4 mm.

4. The decorative member according to claim 1, wherein the cut-out pattern portion comprises a separated piece which is disposed in the through-hole separated from an inner periphery of the through-hole.

5. The decorative member according to claim 4, wherein a surface area of the separated piece is at least 0.03 mm².

6. The decorative member according to claim 1, wherein an average thickness of the board is between 0.1 mm and 0.5 mm.

7. The decorative member according to claim 1, further comprising: a decorative resin which impregnates the first surface of the board,
wherein the resin film and the decorative resin are adhered to each other.

8. A laminate for a decorative member, the laminate comprising:
a board comprising a cut-out pattern portion and a first surface; and
a resin film adhered to the first surface of the board,
wherein the cut-out pattern portion comprises a through-hole which penetrates the board in a thickness direction thereof.

9. The decorative member according to claim 8, wherein a minimum width of the through-hole is between 0.2 mm and 0.4 mm.

10. The decorative member according to claim 8, wherein the cut-out pattern portion comprises a separated piece which is disposed in the through-hole separated from an inner periphery of the through-hole.

11. The decorative member according to claim 10, wherein a surface area of the separated piece is at least 0.03 mm².

12. The decorative member according to claim 8, wherein an average thickness of the board is between 0.1 mm and 0.5 mm.

13. The decorative member according to claim 8, further comprising: a decorative resin which impregnates the first surface of the board,
wherein the resin film and the decorative resin are adhered to each other.

14. A method for manufacturing a decorative member, the method comprising:
adhering a resin film to a first surface of a board comprising a cut-out pattern portion;
disposing, in a cavity of a mold, the board having the resin film adhered thereto; and
supplying an injection resin to a second surface of the board disposed in the cavity,
wherein the cut-out pattern portion comprises a through-hole which penetrates the board in a thickness direction thereof.

15. The method for manufacturing a decorative member according to claim 14, wherein
the through-hole is filled with the injection resin, and
the resin film and the injection resin are adhered to each other at an end on the first surface in the through-hole.

16. The method for manufacturing a decorative member according to claim 14, wherein a minimum width of the through-hole is between 0.2 mm and 0.4 mm.

17. The method for manufacturing a decorative member according to claim 14, wherein the cut-out pattern portion comprises a separated piece which is disposed in the through-hole separated from an inner periphery of the through-hole.

18. The method for manufacturing a decorative member according to claim 17, wherein a surface area of the separated piece is at least 0.03 mm².

19. The method for manufacturing a decorative member according to claim 14, wherein an average thickness of the board is between 0.1 mm and 0.5 mm.

20. The method for manufacturing a decorative member according to claim 14, further comprising: impregnating the first surface of the board with a decorative resin,
wherein the resin film and the decorative resin are adhered to each other.
